(19) United States
(12) Patent Application Publication
(10) Pub. No.: US 2024/0285105 A1
(43) Pub. Date: Aug. 29, 2024

(54) ELECTRIC BLANKET

(71) Applicant: Ningbo Pengzhu Technology Co., LTD, Yuyao (CN)

(72) Inventors: Long Huang, Yongcheng (CN); Fugui Huang, Yuyao (CN)

(21) Appl. No.: 18/175,957

(22) Filed: Feb. 28, 2023

(51) Int. Cl. A47G 9/02; H05B 3/34

(52) U.S. Cl. CPC A47G 9/0215; H05B 3/342

(57) ABSTRACT

An electric blanket comprises the electric blanket fabric provided with multiple quilting in interlaced multi-line stitches; the electric blanket fabric is provided with a heating element around the quilting stitches, and the heating element is provided with a coupler for connecting to a controller; the heating element consists of a core, an inner conductor, an intermediate layer, an outer conductor, a film layer and an outer jacket from inside to outside. The invention has the following advantages: reasonable structural design and excellent heating effects realize a comfortable customer experience of the machine washable blanket, with excellent promotion prospects.

### 1. TECHNICAL FIELD

The invention relates to an electric blanket.

### 2. BACKGROUND ART

With the development of society, people have increasingly high requirements for a better quality of life. During cold winters, people commonly adopt electric blankets to maintain warmth when they sleep in places without heating. However, the existing electric blankets generally use metal electric heating wire as the heating material, which requires a relatively higher power supply voltage. The high voltage will cause electric shock in case of leakage, with negative safety performance. Furthermore, the higher voltage requires higher requirements for the power or power supply method.

### 3. SUMMARY OF THE INVENTION

The invention intends to solve the above problems in the background technology and provide an electric blanket.

To solve the above problems, the invention provides the following technical solution: An electric blanket comprises the electric blanket fabric provided with multiple quilting in interlaced multi-line stitches; the electric blanket fabric is provided with a heating element around the quilting stitches, and the heating element is provided with a coupler for connecting to a controller;

And the heating element consists of a core, an inner conductor, an intermediate layer, an outer conductor, a film layer and an outer jacket from inside to outside.

Preferably, the electric blanket fabric is made of flannel on one side and lambswool on the other.

Preferably, the electric blanket fabric is made of double-sided flannel.

Preferably, the electric blanket fabric is made of double-sided lambswool.

Preferably, the electric blanket fabric is made of double-sided plush.

Preferably, the electric blanket fabric is made of plush on one side and lambswool on the other.

Preferably, the electric blanket fabric is made of PV fleece on one side and lambswool on the other.

Preferably, the electric blanket fabric is made of PV fleece on both sides.

Preferably, the electric blanket fabric is made of back-printed weft-knitted coral fleece on both sides.

Preferably, the core is a polyester thread 1500 D.

Preferably, the inner conductor is made of pure nickel material.

Preferably, the intermediate layer is made of NTC resin.

Preferably, the outer conductor is made of pure copper material.

Preferably, the film layer is made of PET material.

Preferably, the outer jacket is made of PVC compound.

Compared to the prior arts, the invention has the following advantages and beneficial effects: reasonable structural design and excellent heating effects realize a comfortable customer experience of the machine washable blanket, with excellent promotion prospects.

### 4. BRIEF DESCRIPTION OF ACCOMPANY DRAWINGS

FIG. 1 is a schematic diagram showing the structure of an electric blanket of the invention.

FIG. 2 is a schematic diagram showing the structure of the heating element of the invention.

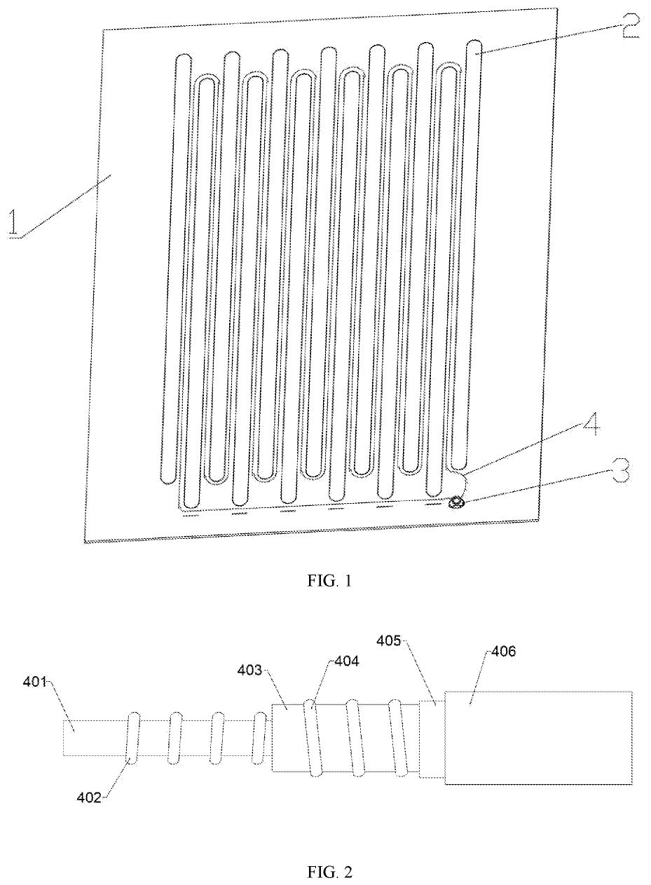

### 5. SPECIFIC EMBODIMENT OF THE INVENTION

In the description of the disclosure, orientation descriptions if mentioned, for example, orientations or positional relationships as indicated by terms such as ‘center’, ‘vertical’, ‘widthwise’, ‘longitudinal’, ‘width’, ‘thickness’, ‘up’, ‘down’, ‘front’, ‘back’, ‘left’, ‘right’, ‘vertical’, ‘horizontal’, ‘top’, ‘bottom’, ‘inside’, ‘outside’, ‘clockwise’, ‘counterclockwise’, are based on the orientations or positional relationships shown in the drawings, and they are intended for facilitating and simplifying the description of the disclosure only, but not indicating or suggesting that the referred device or element must have such a specific orientation, or be constructed and operated in such a specific orientation, and thus, those orientations or positional relationships shall not be construed as limitations to the disclosure.

In addition, terms such as ‘first’ and ‘second’ are used herein for purposes of description and are not intended to indicate or imply relative importance or significance or to imply the number of indicated technical features. Thus, the feature defined with ‘first’ and ‘second’ may comprise one or more of these features. In the description of the disclosure, ‘a plurality of’ means two or more than two, unless specified otherwise.

It should be noted that unless otherwise specified, if a certain feature is referred to be ‘set’, ‘fixed’, or ‘connected’ to another feature, it can be directly set, fixed, or connected to another feature, or indirectly set, fixed, or connected to another feature. In the description of the embodiments of the invention, if it refers to ‘several’, it means more than one; if it refers to ‘a plurality of’, it means more than two; if it refers to ‘greater than’, ‘less than’, and ‘exceeding’, it should be understood as not including the current number; and if it refers to ‘over’, ‘below’ and ‘within’ should be understood as including the current number. If ‘first’ and ‘second’ are involved, it should be understood as used to distinguish technical features, but cannot be understood to indicate or imply relative importance or implicitly indicate the number of indicated technical features or implicitly indicate the precedence relation of the technical features.

To make the technical solutions provided by the invention more comprehensible, the accompanying drawings required for use in the description of embodiments, or the prior art are briefly described below. The preferred embodiment of the invention is presented in the accompanying drawings. However, the invention can be implemented in numerous different forms and is not limited to the embodiments described herein. On the contrary, these embodiments are provided for the purpose of achieving a more comprehensive and thoughtful understanding of the disclosure of the invention.

Referring to the accompanying drawings, an electric blanket, wherein comprises the electric blanket fabric 1 provided with multiple quilting in interlaced multi-line stitches 2; the electric blanket fabric 1 is provided with a heating element 4 around the quilting stitches 2, and the heating element 4 is provided with a coupler for connecting to a controller 3.

The heating element consists of a core 401, an inner conductor 402, an intermediate layer 403, an outer conductor 404, a film layer 405 and an outer jacket 406 from inside to outside.

As a preferred embodiment of the invention, the electric blanket fabric 1 is made of flannel on one side and lambswool on the other.

As a preferred embodiment of the invention, the electric blanket fabric 1 is made of double-sided flannel.

As a preferred embodiment of the invention, the electric blanket fabric 1 is made of double-sided lambswool.

As a preferred embodiment of the invention, the electric blanket fabric 1 is made of double-sided plush.

As a preferred embodiment of the invention, the electric blanket fabric 1 is made of plush on one side and lambswool on the other.

As a preferred embodiment of the invention, the electric blanket fabric 1 is made of PV fleece on one side and lambswool on the other.

As a preferred embodiment of the invention, the electric blanket fabric 1 is made of PV fleece on both sides.

As a preferred embodiment of the invention, the electric blanket fabric 1 is made of back-printed weft-knitted coral fleece on both sides.

As a preferred embodiment of the invention, the core 401 is a polyester thread 1500 D.

As a preferred embodiment of the invention, the inner conductor 402 is made of pure nickel material.

As a preferred embodiment of the invention, the intermediate layer 403 is made of NTC resin.

As a preferred embodiment of the invention, the outer conductor 404 is made of pure copper material.

As a preferred embodiment of the invention, the film layer 405 is made of PET material.

As a preferred embodiment of the invention, the outer jacket 406 is made of PVC compound.

The technical features in the foregoing embodiments may be randomly combined. For a concise description, not all possible combinations of the technical features in the embodiments are described. However, the combinations of the technical features are all to be considered as falling within the scope described in this specification provided that they do not conflict with each other. The invention and the embodiments thereof are described hereinabove, and the descriptions only show several implementations of the disclosure. What is shown in the embodiments in detail are the preferred embodiments of the invention, and the actual structure is not limited thereto. In summary, various modifications and improvements based on the technical solution without departing from the inventive purpose of the invention made by inspired ordinary technicians in the art without creative efforts shall all fall within the protection scope of the invention. It is intended that the scope of the invention be defined by the claims appended hereto and their equivalents.

1. An electric blanket, wherein comprises the electric blanket fabric provided with multiple quilting in interlaced multi-line stitches; the electric blanket fabric is provided with a heating element around the quilting stitches, and the heating element is provided with a coupler for connecting to a controller;
the heating element consists of a core, an inner conductor, an intermediate layer, an outer conductor, a film layer and an outer jacket from inside to outside.

2. An electric blanket according to claim 1, wherein the electric blanket fabric is made of flannel on one side and lambswool on the other.

3. An electric blanket according to claim 1, wherein the electric blanket fabric is made of double-sided flannel.

4. An electric blanket according to claim 1, wherein the electric blanket fabric is made of double-sided lambswool.

5. An electric blanket according to claim 1, wherein the electric blanket fabric is made of double-sided plush.

6. An electric blanket according to claim 1, wherein the electric blanket fabric is made of plush on one side and lambswool on the other.

7. An electric blanket according to claim 1, wherein the electric blanket fabric is made of PV fleece on one side and lambswool on the other.

8. An electric blanket according to claim 1, wherein the electric blanket fabric is made of PV fleece on both sides.

9. An electric blanket according to claim 1, wherein the electric blanket fabric is made of back-printed weft-knitted coral fleece on both sides.

10. An electric blanket according to claim 1, wherein the core is a polyester thread 1500 D.

11. An electric blanket according to claim 1, wherein the inner conductor is made of pure nickel material.

12. An electric blanket according to claim 1, wherein the intermediate layer is made of NTC resin.

13. An electric blanket according to claim 1, wherein the outer conductor is made of pure copper material.

14. An electric blanket according to claim 1, wherein the film layer is made of PET material.

15. An electric blanket according to claim 1, wherein the outer jacket is made of Polyvinyl chloride compound.
